(19) United States
(12) Patent Application Publication
(10) Pub. No.: US 2026/0110785 A1
(43) Pub. Date: Apr. 23, 2026

(54) CALIBRATION DEVICE FOR A LASER VELOCIMETER

(71) Applicant: COMMISSARIAT À L'ENERGIE ATOMIQUE ET AUX ENERGIES ALTERNATIVES, PARIS (FR)

(72) Inventors: Jean-Pascal ALFILLE, LA FERTE ALAIS (FR); Aurélie AZZOLINA, SAINTE GENEVIEVE DES BOIS (FR); Jacky BENIER, Avrainville (FR); Frédéric DESSEROUER, Les Molières (FR)

(21) Appl. No.: 19/360,805

(22) Filed: Oct. 16, 2025

(30) Foreign Application Priority Data
Oct. 18, 2024 (FR) 2411358

(51) Int. Cl. G01S 7/497; G01S 7/481; G01S 17/58

(52) U.S. Cl. CPC G01S 7/497; G01S 7/4818; G01S 17/58

(57) ABSTRACT

A calibration device intended to be coupled to a laser velocimeter includes a disk; a mirror rigidly connected to the disk; a first illumination/reception device to: receive a first light signal at a first frequency; orient and focus the first light signal so as to form a first incident signal illuminating the surface of the mirror at a normal incidence for a position of the disk during a passage of the disk, and over a diameter on the determined surface; recover a first signal reflected by the mirror at a frequency shifted from the first frequency by a Doppler shift (Δf); with the calibration device also to output at least a fraction of the first reflected signal and a value of a first standard tangential velocity determined from the angular velocity (ω) and the measurement radius, intended for the laser velocimeter to be calibrated.

### CROSS-REFERENCE TO RELATED APPLICATION

This application claims priority to foreign French patent application No. FR 2411358, filed on Oct. 18, 2024, the disclosure of which is incorporated by reference in its entirety.

### FIELD OF THE INVENTION

The present invention relates to the field of metrology devices, and more specifically to devices based on laser velocimetry, known as laser velocimeters. A laser velocimeter is a laser-based instrument used to measure the velocity of a moving object (translation, rotation, vibration phenomena, etc.) illuminated by the laser, using the Doppler effect. The invention more specifically relates to devices for calibrating the velocity of laser velocimeters.

### BACKGROUND

When the velocity of an object is moderate, up to approximately one hundred meters per second, and if the distance traveled by this object can be easily accessed via detectors, a simple time measurement between two measurement points can suffice for determining the average velocity of the object with a good degree of precision.

Therefore, there is no actual technical problem in terms of computing the velocity of the object, since the two basic quantities, namely, the distance traveled and the time of flight, are both measurable. Furthermore, if the two distance and time quantities are precisely measured, the deduced average velocity of the object also can be determined with a high degree of precision.

The two main means for measuring high object velocities are as follows: High-speed cameras: historically, the first devices were high-speed optical cameras. They can record a sequence of around a hundred images at a very high rate (typically 4.10⁶ images/s) over short periods of time (typically 20 μs). These techniques are difficult to implement and require the moving object to be visible to the camera, which is not always the case. In practice, as the scrolling time between each image is known, the velocity of the object is known by virtue of the evolution of the position of the object in each image. It should be noted that high-speed camera technologies are rarely used since they are particularly expensive (approximately €300,000.00 to €1 million) for one measurement channel.

Laser velocimetry: the second most commonly used means for measuring velocity is laser velocimetry, and notably heterodyne velocimetry (HV). Heterodyne velocimetry is very appealing because it allows measurements to be taken in difficult conditions, for example, when the object is not accessible to either timing instruments or for remote observation. Indeed, optical velocity measurement probes are small (around 1 mm in diameter and 10 mm in length) and can be easily integrated into an experiment. The velocity information is transferred from the probe to the acquisition bay of the measurement instrument via a single-mode optical fiber with a very small cross-section. Numerous industrial and research applications exist by virtue of the ease of implementation for the moderate cost of the heterodyne laser velocimetry measurement system (approximately €25,000.00 for one measurement channel).

As is known, a laser velocimeter typically comprises a transmission/reception device configured to transmit a light signal at a known frequency and to receive a signal reflected by the moving object, and a measurement module configured, on the one hand, to superimpose a reference signal at the known frequency and the reflected signal and, on the other hand, to detect the beat signal resulting from the interference of the two signals, which has a beat frequency due to the Doppler effect, known as the Doppler frequency. The velocimeter also comprises a processing unit configured to digitize the beat signal and to extract information concerning the velocity of the object from this Doppler frequency.

The velocity is determined by applying the known formula:

$${v}_{obj} = λ \cdot fd / 2 ,$$

where v_{obj} is the velocity of the object, λ is the wavelength of the laser illumination, and fd is the Doppler frequency.

The calibration device for a laser Doppler velocimeter (LVC) described in the publication entitled, “Simple and accurate calibration system for Laser Doppler”, by Terre et al., International Journal of Light and Electron Optics 179 (2019), can be cited that uses a rotating optical chopper disk for velocity calibration up to 30 m/s (1,914 m/min). The disk simulates the velocity of an object with a reference velocity vref equal to r_{ω}, with r being the radius of the disk and ω being the angular velocity, which is precisely known and is measured using a dedicated laser, the beam of which passes through the chopper on its periphery, and a detector. The velocimeter also illuminates the rotating disk on the edge thereof and measures its velocity, which is compared with vref.

In general, the velocities reached by rotating disks are limited to approximately 20-30 m/s. To date, a calibration device does not exist that is easy to implement for setting an object in motion over a wide velocity range up to 5,000 m/s.

### SUMMARY OF THE INVENTION

An aim of the present invention is to overcome the aforementioned disadvantages by proposing a calibration device that can generate stabilized standard velocities in the range of 1-5,000 m/s and that can be easily deployed without any specific constraints.

According to a first aspect, the invention relates to a calibration device intended to be coupled to a laser velocimeter comprising:
a disk configured to rotate about an axis of rotation at a determined angular velocity;
a mirror (M) rigidly connected to the disk, having a surface;
a first illumination/reception device configured to:
   receive a first light signal at a first frequency, said first light signal originating from the laser velocimeter;
   orient and focus the first light signal so as to form a first incident signal illuminating the surface of the mirror at a normal incidence for a position of the disk during a passage of the disk, and over a diameter on said determined surface, with the center of said diameter being located at a determined measurement distance from said axis of rotation;
   recover a first signal reflected by the mirror at a frequency shifted from the first frequency by a Doppler shift;
with said calibration device also being configured to output at least a fraction of said first reflected signal and a value of a first standard tangential velocity determined from said angular velocity and said measurement radius, intended for said laser velocimeter to be calibrated.

According to one variant, the calibration device further comprises a reinjection device configured to recover, amplify and reinject, into the first illumination/reception device, the first reflected signal and a plurality of additional reflected signals formed by successive reflections on said mirror during said passage of the disk. The calibration device is also configured to output a fraction of said plurality of additional reflected signals, intended for said laser velocimeter to be calibrated.

According to one embodiment, the first illumination/reception device is fiber-optic and wherein the reinjection device comprises a first coupler, a first optical amplifier and an optical fiber mirror.

According to another embodiment, the first illumination/reception device is fiber-optic and wherein the reinjection device comprises a second coupler and a second optical amplifier configured to loop back onto the second coupler.

According to one embodiment, the disk comprises through-patterns evenly disposed on the periphery of the disk over a determined radius, the calibration device further comprising a second illumination/reception device configured to:
receive a second light signal at a second frequency, said second light signal originating from the laser velocimeter;
orient and focus the second light signal so as to form a second incident signal illuminating, with a non-zero angle of incidence (a) relative to the plane of the disk, either the patterns or the surface of the disk depending on the position of the disk during rotation;
recover a second signal backscattered by the disk, alternating between a second non-zero amplitude signal originating from the backscattering of the surface of the disk, and a second zero amplitude signal when the second incident signal passes through the disk via a pattern,
with said calibration device also being configured to provide said laser velocimeter with at least a fraction of said second backscattered signal.

According to one embodiment, the calibration device is also intended to be coupled to a laser rangefinder, with the disk then comprising through-patterns evenly disposed on the periphery of the disk on a determined radius, the calibration device further comprising:
a backscattering object disposed under the disk at a determined distance from the disk and so as to backscatter light that has passed through the patterns;
a third illumination/reception device configured to:
   receive a third light signal at a third frequency, with said third light signal originating from the laser rangefinder;
   orient and focus the third light signal so as to form a third incident signal illuminating, along an axis of incidence normal to the surface of the disk, either the through-patterns or the surface of the disk depending on the position of the disk during rotation;
   recover a third backscattered signal (SR3′) alternating between a third signal backscattered by the disk and a third signal backscattered by the object,
with said calibration device also being configured to supply said laser rangefinder (TL) with at least a fraction of said third backscattered signal.

According to one embodiment, the object is configured to be positioned at a plurality of determined distances along said axis of incidence of the third incident signal.

According to one embodiment, the calibration device further comprises a balancing mass disposed on the disk and intended to balance a mass of the mirror.

According to one embodiment, the disk has, at least on its periphery, a thickness that decreases with respect to a distance from the axis of rotation.

According to one embodiment, the through-patterns are notches located on the periphery of the disk.

According to one embodiment, the disk is made of two materials, with a first material for a central part of the disk and a second material for a peripheral part.

According to one embodiment, the calibration device is configured so that a first maximum standard tangential velocity reached by the disk is greater than or equal to 100 m·s⁻¹.

According to another aspect, the invention relates to a calibrated velocity measurement system comprising a laser velocimeter and a calibration device according to the first aspect of the invention, the laser velocimeter being configured to be coupled to said calibration device during calibration, the laser velocimeter comprising:
a transmission/reception device configured to transmit the first light signal at said first frequency and to receive a frequency-shifted signal reflected by a target;
a measurement module configured to superimpose a reference signal and said signal reflected by the target, and to detect a beat signal at a beat frequency corresponding to the frequency shift;
a processing unit configured to digitize the beat signal and to extract velocity information from the beat frequency.

The laser velocimeter is also configured, during calibration, to receive said value of a first standard tangential velocity delivered by the calibration device and such that:
the transmission/reception device transmits said first light signal at said first frequency to the calibration device;
the transmission/reception device receives, from the calibration device, the fraction of said first reflected signal having a frequency shifted from the first frequency by a Doppler shift corresponding to said first standard tangential velocity; and
the fraction of the plurality of additional reflected signals respectively having a frequency shifted from the first frequency by a plurality of shifts equal to i times the Doppler shift, with i varying from 2 to n;
the processing unit extracts a first tangential measurement velocity from said Doppler shift that is to be compared with the first standard tangential velocity, and extracts a plurality of associated additional tangential measurement velocities from said plurality of shifts equal to i times the Doppler shift that are to be respectively compared with a plurality of additional standard tangential velocities respectively equal to i times the first standard tangential velocity.

The following description presents several embodiments of the device of the invention: these embodiments by no means limit the scope of the invention. These embodiments present both the essential features of the invention and additional features related to the considered embodiments.

### BRIEF DESCRIPTION OF THE DRAWINGS

The invention will be better understood and further features, aims and advantages thereof will become apparent throughout the following detailed description and with reference to the accompanying drawings, which are provided by way of non-limiting examples and in which:

FIG. 1 illustrates a calibration device according to the invention.

FIG. 2 illustrates an example of the implementation of the calibration device according to the invention.

FIG. 3 illustrates a variant of the calibration device according to the invention adapted for high-velocity calibration and comprising a reinjection device.

FIG. 4 illustrates a first embodiment of the variant with a reinjection device in which the reinjection device comprises a first coupler, a first optical amplifier and an optical fiber mirror.

FIG. 5 illustrates a time/velocity spectrogram of an example of velocity multiplication according to the first embodiment of the variant with a reinjection device.

FIG. 6 illustrates a second embodiment of the variant with a reinjection device, in which the reinjection device comprises a second coupler and a second optical amplifier configured to loop back to the second coupler.

FIG. 7 illustrates a time/velocity spectrogram of an example of velocity multiplication according to the second embodiment of the variant with a reinjection device, for the case of a velocity obtained without a loop.

FIG. 8 illustrates a time/velocity spectrogram of an example of velocity multiplication according to the second embodiment of the variant with a reinjection device, for the case of velocities obtained with the loop but without the amplifier.

FIG. 9 illustrates a time/velocity spectrogram of an example of velocity multiplication according to the second embodiment of the variant with a reinjection device, for the case of velocities obtained with the loop and the amplifier operating.

FIG. 10 illustrates a variant of the calibration device according to the invention, in which the calibration device is also configured to generate periodic and rapid velocity transitions, and to this end comprises through-patterns. FIG. 8 also illustrates a variant of the calibration device according to the invention, in which the calibration device is intended to be coupled to a laser rangefinder TL, in order to allow the calibration device to calibrate itself remotely. To this end, the disk includes a backscattering object disposed under the disk. FIG. 8 also illustrates a variant of the calibration device according to the invention, in which the rotating disk is disposed in a vacuum containment chamber.

FIG. 11 illustrates a rotating disk optimized for the calibration device according to the invention, having a variable thickness, which is thicker at the center than at the edge, which is made of two materials and whose through-patterns are notches located on the periphery of the disk.

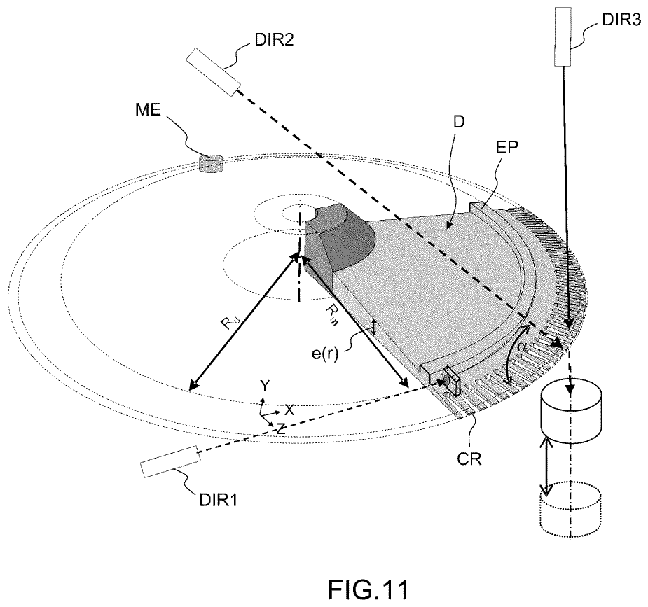

FIG. 12 illustrates a calibrated velocity measurement system according to a second aspect of the invention.

### DETAILED DESCRIPTION

The basic idea of the invention is to use a rotating metrology disk simulating the movement of an object as a calibration device. The calibration device 10 according to a first aspect of the invention is thus a standard velocity generator for an object. It is intended to be coupled to an industrial measurement system of the laser velocimeter VL type, for example, a heterodyne laser velocimeter (VLH), in order to verify the accuracy of the velocities fed back by the latter. In other words, it involves verifying whether the industrial VL measurement system is correctly calibrated across its entire measurement range.

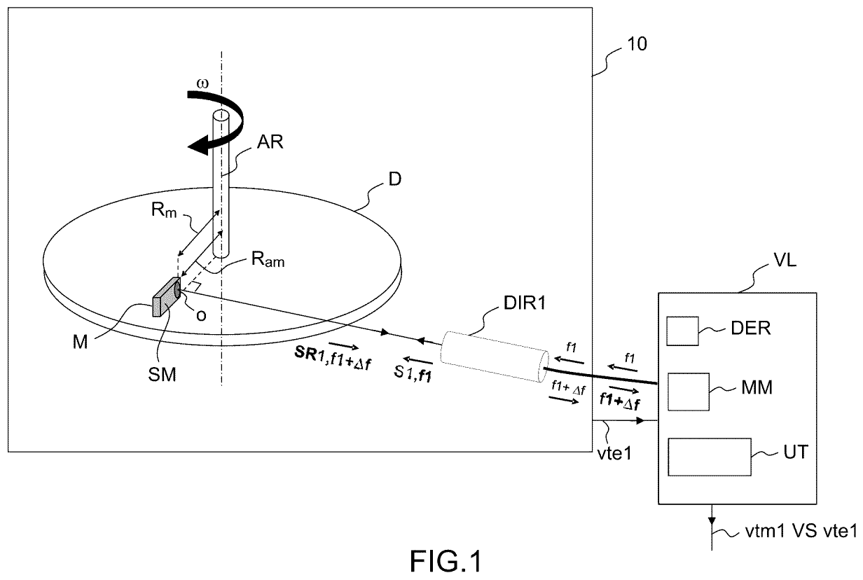

The calibration device 10 according to the invention is illustrated in FIG. 1. It is intended to be coupled to a laser velocimeter VL, also shown in FIG. 1, but not forming part of the invention according to a first aspect.

By way of a reminder, in a known manner, a laser velocimeter VL comprises a transmission/reception device DER configured to transmit a light signal at a first frequency f1 and to receive a frequency-shifted signal reflected by an object to be characterized. It also comprises a measurement module MM configured to superimpose a reference signal and the reflected signal, and to detect a beat signal at a beat frequency corresponding to the frequency shift between the reference signal (at the frequency f1) and the reflected signal, frequency-shifted by a shift resulting from the Doppler effect. Finally, the velocimeter VL comprises a processing unit UT configured to digitize the beat signal and to extract velocity information concerning the object from the beat frequency.

The calibration device 10 is produced independently of the velocimeter VL and is coupled to VL when its calibration is required.

The calibration device 10 according to the invention comprises a disk D configured to rotate about a rotation axis AR at a precisely determined, i.e., known, angular velocity ω. The precise measurement of the rotation velocity of the disk is obtained, for example, from an electronic reference (clock) originating from the command of the electric motor for setting the disk into rotation. According to another example, an optical revolution counting device measuring the rotation frequency f of the disk is integrated into the calibration device according to the invention, and the angular velocity is determined by the relationship ω=2·π·f.

The calibration device also comprises a mirror M rigidly connected to the disk, having a surface SM. The mirror is preferably placed on the periphery of the disk so that its tangential velocity is as high as possible given the rotation velocity ω.

The calibration device also comprises a first illumination/reception device DIR1 configured to receive a first light signal S1 at a first frequency, with the first light signal S1 originating from the laser velocimeter. The laser velocimeter typically has a fiber-optic or free-space output. The device DIR1 is preferably (but not necessarily) fiber-optic. When both VL and DIR1 are fiber-optic, a coupler is used to join the two fibers.

The device DIR1 is also configured to orient and focus the first light signal so as to form a first incident signal illuminating the surface of the mirror SM at a normal incidence for a given position of the disk during a passage of the rotating disk. The incident beam has a diameter Dsp (radius Rsp) on the surface SM and the position of the center O of the diameter of the incident beam on the mirror relative to the axis of rotation is precisely known, with this distance being denoted Rm. Typically, the diameter of the beam Dsp is around 10⁻¹⁰⁰ μm. For example, the distance Roe between the point O and the end of the mirror on the axis of rotation side and the distance Ram between the end of the mirror on the axis of rotation side and the axis of rotation AR are known. The center O of the diameter of the incident beam on the mirror is thus located at the measurement distance Rm from the axis of rotation AR, which is precisely known, and is equal, for example, to:

$$Rm = Ram + Rsp .$$

The tangential velocity of the mirror at the point O, referred to as the first standard tangential velocity vte1, is therefore precisely known using the formula:

$$vte 1 = ω \cdot Rm$$

Preferably, the surface of the mirror is parallel to a radius of the disk, but this is not compulsory. The mirror needs to be set for autocollimation relative to the incident beam, i.e., so as to return the reflected light along the same path as the outward path. Given the rotation velocity of the disk, the mirror remains set for autocollimation for only a short time during a passage, typically of around 1 μs.

The device DIR1 is configured to recover a first signal SR1 reflected by the mirror at a frequency shifted from the first frequency f1 by a Doppler shift Δf originating from the tangential velocity of the mirror at the point O. Thus, during the rotation of the disk and when the mirror is, for a brief instant, perpendicular to the incident beam at the frequency f1, the return beam reflected by the mirror is frequency-shifted by the Doppler effect (frequency f1+Δf) corresponding to the tangential velocity of the rotating mirror. The reflected beam containing the information [f1+Δf] returns to the device DIR1, which is also known as the probe.

The calibration device 10 is also configured to provide, as output from the device:
on the one hand, the value of the first standard tangential velocity vte1, determined from the angular velocity ω and said measurement radius Rm, both of which are precisely known;
on the other hand, at least a fraction of the first reflected signal SR1 at the frequency f1+Δf, conveying frequency information Δf associated with the first standard tangential velocity vte1, otherwise known.

This output data is intended to be fed to the laser velocimeter VL to be calibrated.

Thus, the device according to the invention constitutes a generator of standard tangential velocities in the range of 1 to 500 m/s from an object (the rotating disk).

The first standard velocity vte1 can reach, with an optimized structure of the disk rotating at its maximum angular velocity, a maximum value of approximately 500 m/s. By virtue of the control of the angular rotation velocity ω of the disk, the tangential velocity on the periphery of the disk can vary over a wide range, typically [1; 500 m/s].

The calibration device according to the invention can be deployed in any premises, without any special infrastructure or safety constraints. Typically, the device 10 is fully enclosed.

It should be noted that the first generated tangential velocity vte1 of the disk is known with a good degree of precision, approximately Δvte1/vte1 of around 10⁻⁴.

This is possible by virtue of the precise knowledge of:
the angular velocity of the disk (ω), measured instantaneously at the time of each calibration,
the value of the radius Rm between the axis of rotation of the disk and the center O of the measurement point of the focused probe.

The angular velocity of the disk is preferably measured continuously in order to monitor its stability.

During calibration, the velocimeter VL is coupled to the device 10 according to the invention and therefore receives the signal SR1 as input, mixes this signal with a reference signal at the frequency f1 and determines the beat frequency related to Δf, from which it extracts a first tangential measurement velocity vtm1. This measured velocity vtm1 is to be compared with the first standard tangential velocity vte1 in order to proceed with the calibration.

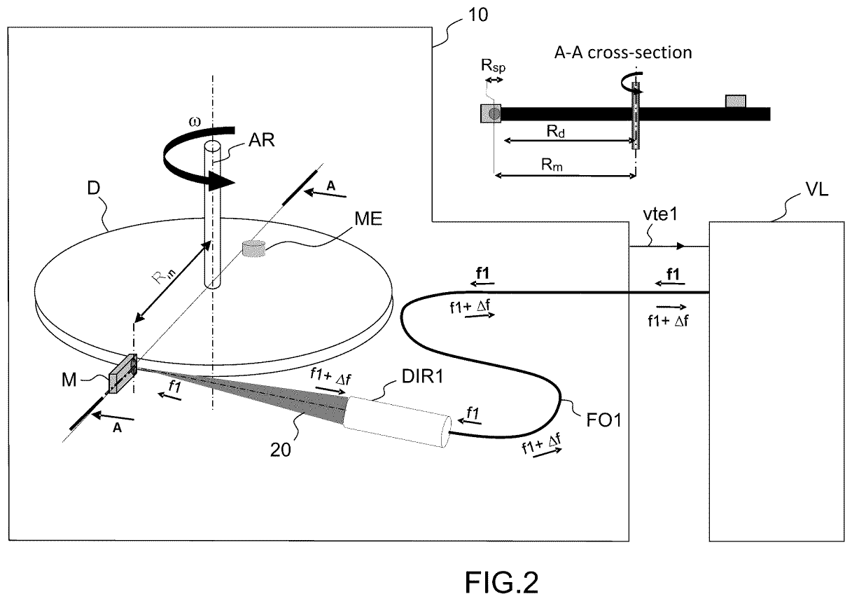

By way of a non-limiting example, an example of the implementation of the calibration device according to the invention is illustrated in FIG. 2. The first illumination/reception device DIR1 is a fiber-optic probe, i.e., comprising an optical fiber FO1. The use of an optical fiber is a preferred embodiment, but the light signals also can be conveyed in free space or in the form of integrated optics. The fiber-optic probe is provided with a focusing device for generating a focused incident beam 20 with a spot diameter Dsp of around 10 μm on the mirror M. The mirror M is attached to the edge of the disk, on its periphery, and the device is configured so that the beam 20 impacts the mirror at a tangent to the edge of the disk (spot tangent to the edge of the disk). The first standard tangential velocity vte1 is then at its maximum and is equal to ω·Rd, where Rd is the radius of the disk D. The measurement radius Rm in this case is equal to:

Rm=Rd+Rsp, where Rsp is the radius of the spot of the beam on the mirror M.

The probe DIR1 is configured to recover the beam reflected during the short period when autocollimation is set, with this reflected beam leaving via the fiber OF1. The optical fiber OF1 fulfils the role of an input/output device enabling coupling with the velocimeter VL.

Optionally, a balancing mass ME is attached to the disk in order to compensate for the mass of the mirror added to the edge of the disk.

The cross-section in the AA direction at the top of FIG. 2 illustrates the particular configuration for which Rm=Rd+Rsp.

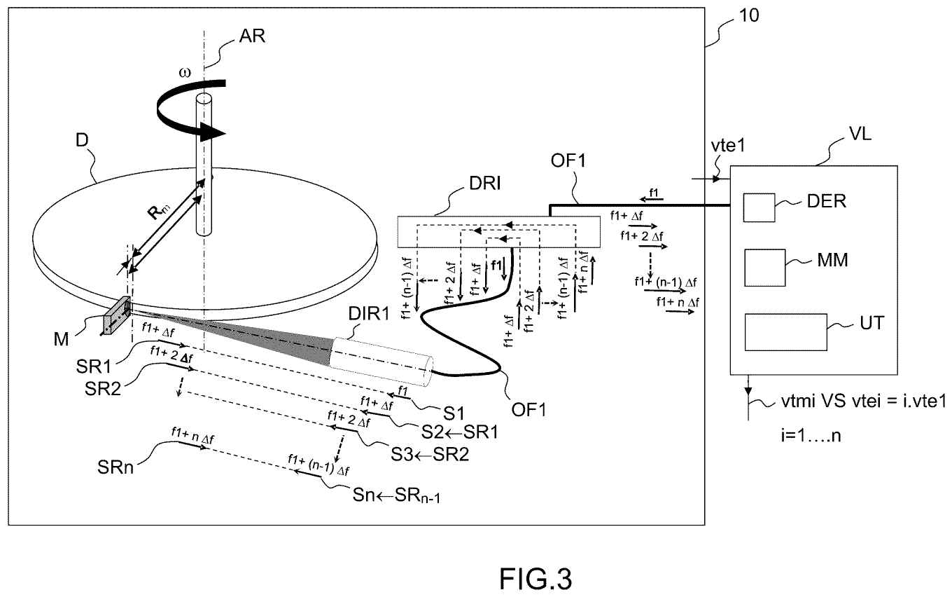

According to a variant, called multiplicative velocity variant, illustrated in FIG. 3, which incorporates, without limitation, the implementation mode of FIG. 2, the calibration device according to the invention is adapted for calibrating high velocities greater than vte1. To this end, the device 10 further comprises a reinjection device DRI configured to recover, amplify and reinject, into the first illumination/reception device DIR1, the first reflected signal SR1 and a plurality of additional reflected signals formed by successive reflections on the mirror M during the autocollimation instant during the passage of the rotating disk. These additional reflected signals SRi are indexed, with i varying from 2 to n, with i=1 corresponding to the first reflected signal SR1 described above. The device DRI is disposed upstream of the device DIR1, between the latter and the output intended to be coupled to the velocimeter.

In this reinjection loop, the signal SR1, of frequency f1+Δf, is recovered, amplified by the device DRI and reinjected, still via this device DRI, into the first illumination/reception device DIR1. It then becomes an incident beam S2 on the mirror: S2=SR1. This beam S2 is in turn reflected by the mirror in order to form SR2 and has a frequency shifted by Δf relative to the frequency of S2 equal to f1+Δf, i.e., a frequency f1+2·Δf, shifted by 2·Δf relative to f1. This beam SR2 is in turn recovered, amplified and reinjected into DRI1 and becomes the incident beam S3=SR2, and so on until a reflected beam Sn with a frequency of f1+n·Δf is obtained. The device 10 according to the invention thus generates a plurality of n reflected beams SRi, respectively having a frequency of f1+i·Δf, that is, a frequency shift by a value of i·Δf relative to f1.

The limit on the number of possible iterations, that is, the value of n, is limited by the attenuation of the beam not compensated by the amplification and by the time during which autocollimation occurs with the measurement probe (DIR1). Indeed, the beam reflected by the mirror very quickly no longer returns along the same path and therefore is not recovered by DIR1. Typically, n ranges between 10 and 25, depending on the rotation velocity of the disk.

The calibration device 10 is also configured to output, in addition to the signal SR1, a fraction of the plurality of additional reflected signals SRi. This additional output data is intended to be fed to the laser velocimeter VL to be calibrated.

During calibration, the velocimeter VL is coupled to the device 10 according to the invention and therefore as input receives, in addition to the signal SR1 and through the same channel, the plurality of additional signals SRi, which are superimposed.

These signals are detected and processed by the velocimeter VL, and the processing unit UT of VL extracts, from the plurality of shifts, equal to i·Δf, a plurality of associated additional tangential measurement velocities vtmi. These measurement velocities vtmi are, for calibration purposes, to be respectively compared with a plurality of additional standard tangential velocities vtei respectively equal to i times the first standard tangential velocity vte1: vtei=i·vte1.

By virtue of the device according to the invention, it has been possible to overcome the constraints exerted on a rotating disk limiting its maximum tangential velocity by generating pseudo standard tangential velocities equal to multiples of the initial tangential velocity vte1. Indeed, modelling the mechanical strength of the disk systematically shows a breakage of the disk in the central drive zone from a tangential velocity of approximately 1,000 m/s, even with the best metal materials that are currently available. It is therefore impossible to directly obtain Doppler shifts (Δf) corresponding to velocities of more than approximately 1,000 m/s.

In order to achieve Doppler shifts corresponding to standard tangential velocities of several hundred or even thousands of meters per second, the device according to the invention duplicates and accumulates the initial Doppler shift Δf, typically corresponding to the maximum standard tangential velocity that actually can be achieved at the edge of the disk (for example, 500 m/s).

In other words, this involves artificially increasing this initial Doppler shift Δf by multiplying it by a factor n, allowing a larger (and well known) range of Doppler shifts to be generated.

Typically, starting from a velocity vte1=500 m/s, standard tangential velocities of 5,000 to 10,000 m/s can be achieved.

The reinjection device forms a specific optical circuit in the form of an optical loop that allows the initial Doppler shift to be multiplied n times. By way of an example, this multiplication of Doppler shifts (n×Δf, with n being from 10 to 20) typically allows pseudo-projectile velocities of 5,000 to 10,000 m/s to be achieved, starting from vte=500 m/s.

In order to obtain a good degree of precision at these high velocities, the uncertainty in the base velocity vte1 must be as low as possible, typically Δvte1/vte1 of around 10⁻⁴ to 10⁻⁵.

The advantage of this multiplicative velocity variant of the device according to the invention is that it is possible to perform a velocity calibration on a moving object over a very wide velocity range, from a few meters to several thousand meters per second.

In the embodiment in which the device DIR1 comprises a first optical fiber OF1, the device DRI is coupled to the device DIR1 via this optical fiber OF1. According to one embodiment that is also shown in FIG. 3, the device DIR1 comprises a second optical fiber OF2 fulfilling the function of an input/output device allowing coupling with the velocimeter VL.

In terms of applications according to one embodiment, the device 10 according to the invention is modular, with a basic mode MB allowing calibration up to vte1, comprising the rotating disk and the device DIR1 provided with the fiber OF1, and a velocity multiplication module MMV integrating the device DRI provided with the optical fiber OF2, with the output of the module MMV being coupled to OF1, which would be added to the basic module as required.

The calibration device according to the invention can operate with an incident light signal at a selected wavelength, the value of which ranges between the far infrared and the UV range, including the visible range. A wavelength of 1,550 nm is commonly implemented in fiber optic communication technologies, and fiber optic components suitable for producing the device according to the invention are therefore commercially available.

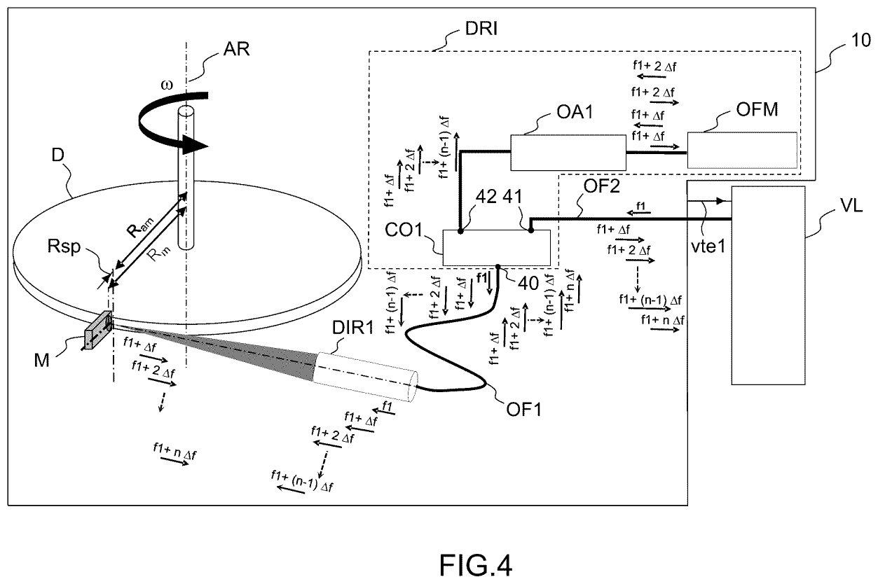

According to a first embodiment of the multiplicative velocity variant illustrated in FIG. 4, which in a non-limiting manner incorporates the embodiment of the mirror attached to the edge of the disk, the first illumination/reception device DIR1 is fiber-optic, i.e., it comprises a first optical fiber OF1, and the reinjection device DIR comprises a first coupler CO1, a first optical amplifier OA1 and an optical fiber mirror OFM. Preferably, it also comprises a second optical fiber OF2 as described above. The first coupler CO1 is typically a 2 (41, 42)×1 (40) coupler comprising three input/output ports 40, 41, 42. The port 40 is connected to DIR1 via the fiber OF1, the port 42 is connected to the optical amplifier OA1, and the other port 41 of the 2×1 coupler is connected to the fiber OF2, which is traversed by the input signal at the frequency f1 (input) and the fraction of reflected signals SRi intended for the calibration (output).

In general, the links between the various components of the calibration device according to the invention typically operate via optical fibers or in free space. Similarly, the components themselves are produced using free-space technologies.

The amplification of the optical signals and the multiplication of the reference Doppler shift Δf is achieved by a succession of round trips in the first amplifier OA1 by virtue of an optical fiber mirror OFM. The purpose of this optical fiber mirror OFM is to return the frequency-shifted signals to the probe DIR1 in order to accumulate the Doppler shifts.

The optical paths of the first Doppler shift duplication (or multiplication) loop are described hereafter with an example:
The initial incident beam S1 at the frequency f1 is recovered by the port 41 of the coupler CO1, for example, a 10% (41)/90% (42) coupler.
The beam S1 passes through the 10/90% two-path coupler CO1, i.e., 10% of the initial power at the frequency f1 is found at the output on the port 40 and is then injected into the optical probe DIR1.
When the disk D rotates, each time the mirror passes in front of the incident beam focused by the DIR1, the beam reflected by the mirror is perfectly perpendicular to the incident beam for a short instant (autocollimation). A significant part of the incident beam is therefore reflected by the mirror and returns to the probe DIR1 with the information from the first Doppler shift (f1+Δf).
This initial Doppler shift Δf corresponds to the actual tangential velocity of the selected disk and represents the tangential velocity reference, called first tangential velocity vte1, which is subsequently duplicated (multiplied).
The return beam SR1 containing the Doppler shift information (f1+Δf) passes back through the coupler CO1 in the opposite direction.
The first output of the 10% coupler 41 returns the signal SR1 shifted by (f1+Δf) to the output of the device 10, typically via OF2, and is injected into the input of the velocimeter VL for calibration. Processing this signal using the processing unit UT of VL, with the shift (Δf), provides the first tangential measurement velocity vtm1 of the disk as seen by VL. If the velocimeter VL is correctly calibrated, then vtm1=vte1.
The second output of the 90% coupler 42 sends this same signal shifted by (f1+Δf) to the first optical amplifier OA1 in order to increase the beam power and to compensate for any losses due to the various components, in particular any losses in the return beam in the probe DIR1.
At the output of the amplifier OA1, a fiber provided with a mirror OFM at the end again returns the signal amplified in the amplifier. This assembly, made up of the amplifier OA1 and the optical fiber mirror OFM, is the optical circuit for returning the beam to the probe DIR1 with a view to multiplying the Doppler shifts. At this stage, the beam frequency is still (f1+Δf).
Then the beam SR1, shifted by (f1+Δf), passes back through the 90% coupler. Finally, the shifted laser beam SR1, still at (f1+Δf), is returned to the probe DIR1 a second time, deflects an incident beam S2 on the mirror, and is then again reflected on the mirror M animated by its tangential velocity vte1.
The return beam SR2 in the probe DIR1 is therefore frequency-shifted by (f1+2×Δf) and re-enters the coupler CO1.
The first output 41 of the 10% coupler returns the signal shifted by 2×Δf to the output and the velocimeter VL. Processing this signal with the 2×Δf shift yields twice the initial tangential velocity vte1 of the disk.
The second output of the 90% coupler returns the beam (f1+2×Δf) to the beam amplification and return loop in the probe DIR1.

The round trips via the multiplication circuit are typically performed between 10 and 20 times. The number of iterations depends on the quality of the signals, which degrade with each amplification, and on the available autocollimation time (depending on the probe and the rotation velocity of the disk).

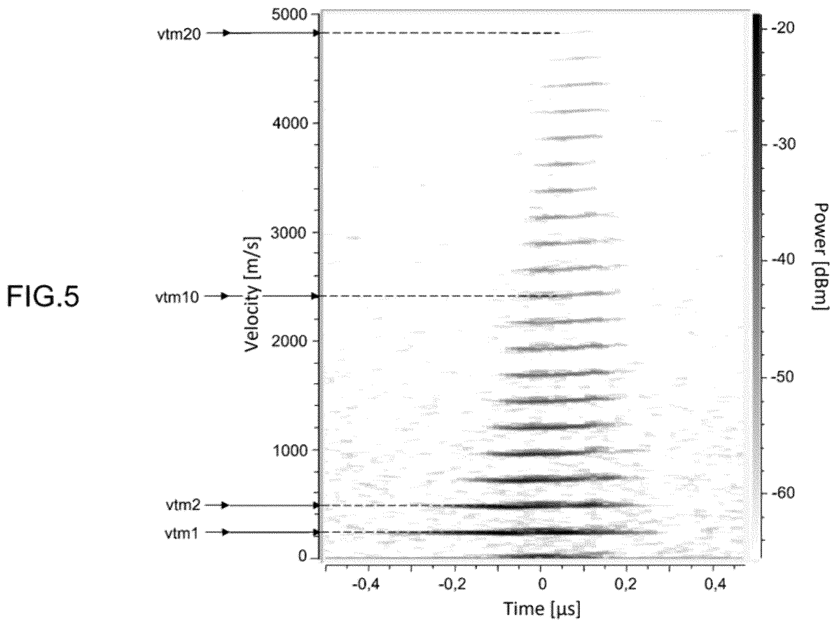

FIG. 5 illustrates a time/velocity spectrogram of an example of velocity multiplication according to the first embodiment (FIG. 4) of the multiplicative velocity variant of the invention. The velocities on the y-axis are the velocities vtmi measured by a velocimeter VL (at the output of the processing unit) coupled to the calibration device generating the various signals SRi.

In the case of this example, the first actual reference standard tangential velocity vte1 is 240 m/s±0.05 m/s. The tangential velocity of vte1=240 m/s is known with a high degree of precision by virtue of the precise knowledge of the product ωRm.

The velocity obtained after one passage Pi is denoted vtmi. After 19 passages in the “multiplicative” loop, corresponding to n=20, the tangential velocity of the pseudo-projectile measured by the industrial VL system reached vtm20=4,800 m/s=20×240 m/s. Since it is known that vtm1 corresponds to vte1 (240 m/s), vtmi corresponds to i times vte1, vtm20 corresponds to 20 times vte1 (that is, 4,800 m/s), the velocity scale in m/s can be precisely calibrated over the entire velocity range between 100 and 5,000 m/s.

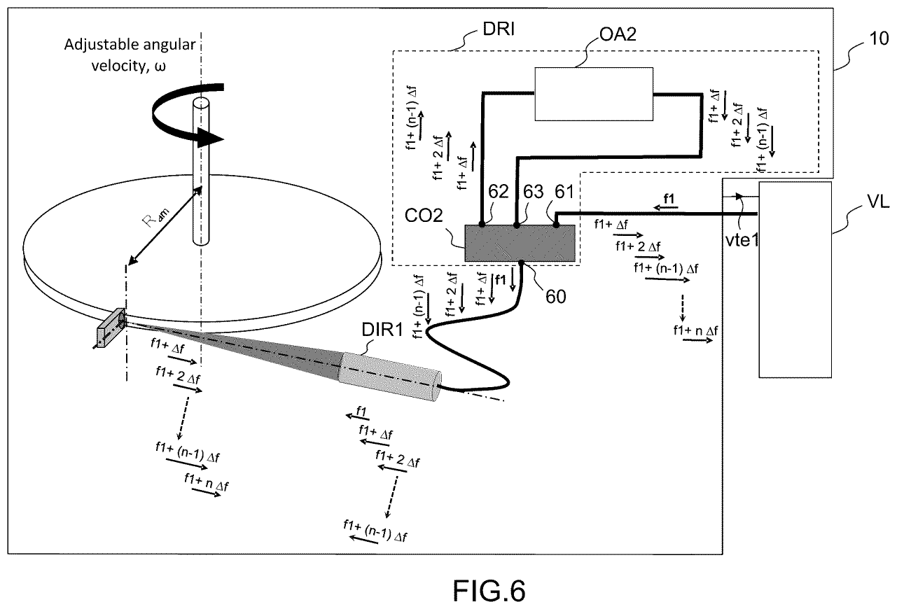

According to a second embodiment of the multiplicative velocity variant illustrated in FIG. 6, which in a non-limiting manner incorporates the embodiment of the mirror attached to the edge of the disk, the first illumination/reception device DIR1 is fiber-optic, i.e., it comprises a first optical fiber OF1 and the reinjection device DIR comprises a second coupler CO2 and a second optical amplifier OA2 configured to loop back to the second coupler CO2.

In this second embodiment, the amplification and the duplication (multiplication) of the reference Doppler shift Δf are performed by a fiber-optic loop. The purpose of this loop is to amplify and return the signals to the probe DIR1 in order to accumulate the Doppler shifts.

In this embodiment, there is no longer an optical fiber mirror for returning the beam, but an actual optical loop.

The optical paths of the first Doppler shift duplication (or multiplication) loop are as follows (FIG. 6):
The initial incident beam S1 at the frequency f1 is recovered by the port 61 of the coupler CO2, for example, a 4-port (60, 61, 62, 63) 3×1 coupler, for example, 33% (61)/33% (62)/33% (63).
The beam passes through the three-path CO2 coupler, for example, 33/33/33: 33% of the initial power at the frequency f1 is found at the output 60 of the coupler and is then injected into the optical probe DIR1.
When the disk rotates, each time the mirror M passes in front of the incident beam focused by the probe DIR1, the beam reflected by the mirror is, for a short instant, perfectly perpendicular to the incident beam (autocollimation) originating from the probe DIR1. A significant part of the incident beam is therefore reflected by the mirror and returns to the probe DIR1 with the information concerning the first Doppler shift (f1+Δf) relative to (once) the tangential velocity of the mirror.
After reflecting on the rotating mirror M, the return beam SR1 containing the Doppler shift information (f1+Δf) passes back through the coupler in the opposite direction (via 60).
The first output 61 of the 33% coupler returns the signal shifted by (f1+Δf) to the output of the device, intended to be coupled to the velocimeter VL. Processing this signal SR1 with the shift (Δf) provides the initial tangential velocity vtm1 of the disk as seen by VL. If the lasers of VL are properly calibrated, then vtm1=vte1.
The second output 62 of the 33% coupler sends this same signal SR1 shifted by (f1+Δf) to a second optical amplifier OA2 in order to increase the power of this beam and to compensate for any losses due to the various components, in particular any losses from the return beam in the probe DIR1.
At the output of the amplifier, the beam is returned to the third 33% path 63 of the coupler. Thus, the beam, which has been amplified again and shifted by (f1+Δf), is returned to the probe DIR1.
The beam originating from the output 62 of the coupler, amplified and returned to the output 63 of the coupler, represents the loop for multiplying the Doppler shifts. At this stage, the beam frequency is still (f1+Δf).
Finally, the shifted laser beam, still at (f1+Δf), is returned to the probe DIR1 a second time, deflects the incident beam S2 and is then again reflected on the mirror animated by its tangential velocity vte1.
The return beam SR2 in the probe DIR1 is therefore frequency-shifted by (f1+2×Δf) and re-enters the coupler via the path 60.
The first output of the 33% coupler 61 returns the signal shifted by 2×Δf to the output and the velocimeter VL. Processing this signal with the 2×Δf shift yields a measured velocity vtm2 corresponding to twice the initial tangential velocity of the disk vte2=2.vte1 if VL is correctly calibrated.
The second output of the 33% coupler 62 returns the beam (f1+2×Δf) to the amplification loop. The beam returns to the probe DIR1 by passing through the coupler from 63 to 60.

The round trips via the multiplication circuit are performed between 10 and 20 times. The number of iterations depends on the quality of the signals, which degrade with each amplification, and the available autocollimation time.

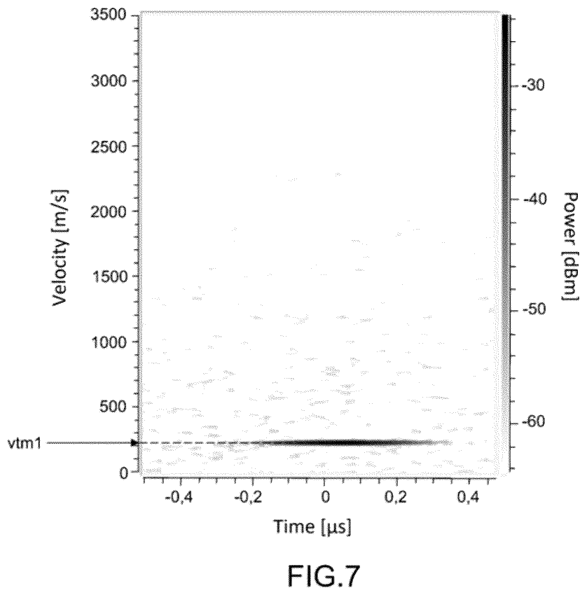

FIGS. 7, 8 and 9 illustrate a time/velocity spectrogram of an example of velocity multiplication according to the second embodiment (FIG. 6) of the multiplicative velocity variant of the invention for three different cases.

As in FIG. 5, the velocities on the y-axis are the velocities vtmi measured by a velocimeter VL coupled to the calibration device generating the various signals SRi.

The spectrogram in FIG. 7 shows the velocity obtained without a loop. This is therefore the measurement vtm1 of the initial tangential velocity of the rotating mirror, which is known to be equal to the standard value of vte1 of 240 m/s, corresponding to the initial Doppler shift Δf.

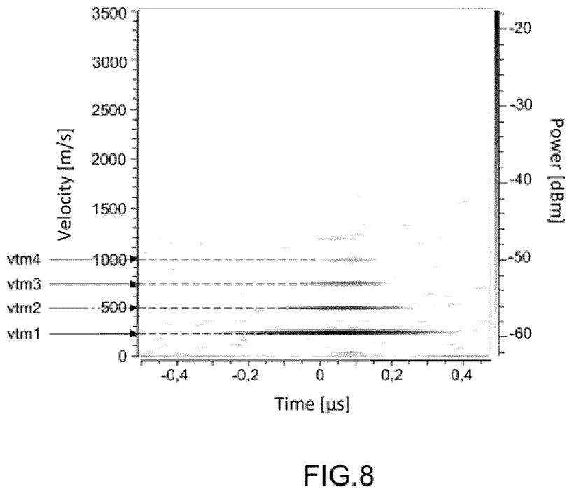

The spectrogram in FIG. 8 shows the velocities obtained with the loop, but without the amplifier OA2. Without the amplifier, the various power losses in the optical circuit still allow the loop to be completed three times and the initial Doppler shift to be multiplied by four, 4×Δf, reaching a tangential velocity of 960 m/s.

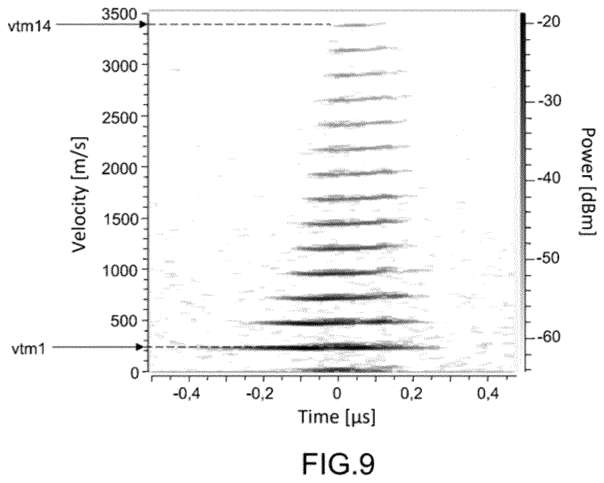

The spectrogram in FIG. 9 shows the velocities obtained with the loop and the amplifier operating. With the amplifier, the various power losses in the optical circuit are reduced, allowing the loop to be completed thirteen times and, in this example, allow the initial Doppler shift to be multiplied by fourteen, 14×Δf, reaching a tangential velocity of 3,360 m/s.

Since it is known that vtm1 corresponds to vte1 (240 m/s), vtmi corresponds to i times vte1, vtm14 corresponds to 14 times vte1 (that is, 3,360 m/s), the velocity scale in m/s can be precisely calibrated over the entire velocity range between 100 m/s and 3,500 m/s.

In order to implement the calibration, the calibration device 10 is coupled to a velocimeter, from which it recovers the signal at the frequency f1. The device 10 stores the value of Rm in a memory. The disk is then rotated at a first tangential velocity to be measured, vte1 (setpoint). To this end, the angular velocity of the disk at the time of the calibration must be measured precisely.

DIR1 is then intended for the rotating mirror and the calibration device returns the useful reflected signal to the velocimeter, which processes it and extracts the velocity measurements.

Based on the standard value vte1 provided by the device 10, the velocimeter computes the multiples i·vte1. The measurement scale of VL can be precisely calibrated in m/s since vte1 and all the velocity multiples accessible by the time/frequency measurement are known. The number of multiples for which the comparison can be made, which is necessarily less than or equal to n, is limited by the sensitivity of the velocimeter for recording weak signals and by the illumination zone of the autocollimation mirror (which decreases with the number of jumps in velocity).

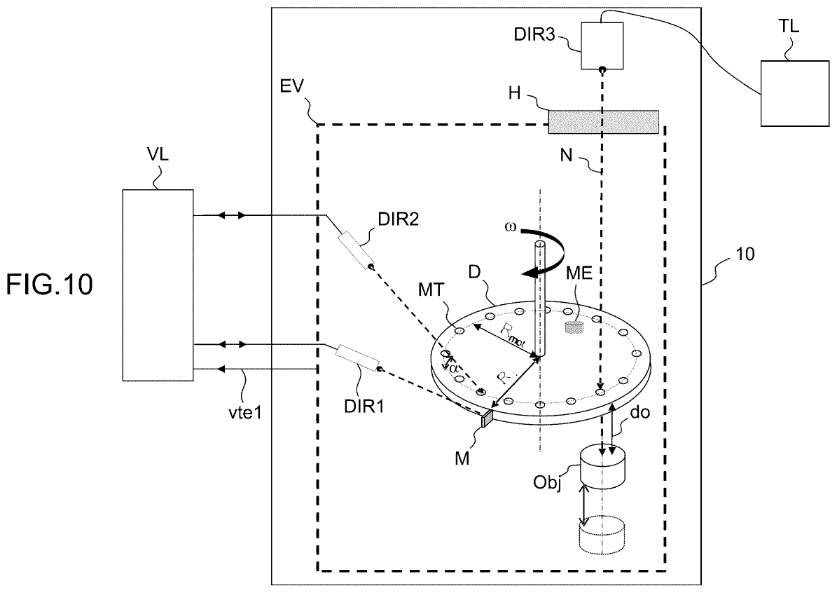

According to a variant illustrated in FIG. 10, the calibration device according to the invention is also configured to generate periodic and rapid velocity transitions (typically less than 20 ns) between the velocity of the moving object (disk) and a fixed reference at zero velocity. To this end, the disk comprises through-patterns MT evenly disposed on the periphery of the disk over a determined radius Rmot. The calibration device 10 further comprises a second illumination/reception device DIR2 configured to receive a second light signal S2′ at a second frequency f2, with the second light signal originating from the laser velocimeter. The frequency f2 can be identical to or different from f1. The illumination/reception device DIR2, or second probe, is also configured to orient and focus the second light signal so as to form a second incident signal illuminating, with an angle of incidence a, which is non-zero relative to the plane of the disk, either the through-patterns MT or the surface of the disk, depending on the position of the disk during the rotation. Thus, periodically, the incident beam is intercepted by the upper surface of the disk or even passes through the patterns. Finally, the device DIR2 is configured to recover a second signal SR2′ backscattered by the disk D, alternating between a second non-zero amplitude signal originating from the backscattering on the surface of the disk and a second zero amplitude signal when the second incident signal passes through the disk via a pattern.

The calibration device 10 is also configured to feed the laser velocimeter VL with at least a fraction of the second backscattered signal SR2′.

For calibration, the velocimeter processes the fraction of the second backscattered signal and thus generates a periodic velocity signal between a non-zero velocity and a zero velocity.

This targeting with the second probe thus generates standard transitions between the tangential velocity of the disk (measurement of the scattering of the incident beam on the surface of the disk) and a zero velocity when the beam passes through one of the perforations in the disk. In other words, a standard velocity transition generator is produced. The controlled transition time (typically >20 ns) depends on the diameter of the focused beam (for example, of around 10 μm) and on the maximum tangential velocity of the disk (vtemax).

This standard velocity transition generator, produced using the second illumination/reception device DIR2 of the calibration device 10 according to the invention, allows the percussive response of the entire acquisition chain of the velocimeter to be qualified (reception, digitization and processing of signals in order to extract velocities) relative to stresses in the form of short, calibrated velocity pulses.

It should be noted that, due to the angle α between the direction of the velocity vm measured by the second probe and the actual direction of the tangential velocity vtm of the disk, the relationship to be applied is: vm=vtm·cos(α).

For the second probe, the measured velocity is therefore always lower than the actual tangential velocity. The uncertainty concerning the angle α is irrelevant since in this case the intention is to know the edge of the transitions in velocity.

According to another variant, which can be combined with the preceding variants and is also illustrated in FIG. 10, the calibration device 10 according to the invention is also intended to be coupled to a laser rangefinder TL, in order to allow the calibration device to calibrate itself by distance. To this end, as for the preceding variant, the disk comprises through-patterns MT evenly disposed on the periphery of the disk over a determined radius Rmot. The calibration device 10 further comprises a backscattering object Obj disposed below the disk at a determined distance do from the disk and in such a way as to backscatter light that has passed through the patterns. The calibration device 10 also comprises a third illumination/reception device DIR3 or third probe, configured to:
receive a third light signal S3′ at a third frequency f3, with the third light signal originating from the laser rangefinder TL;
orient and focus the third light signal so as to form a third incident signal illuminating, along an axis of incidence N normal to the surface of the disk, either the through-patterns or the surface of the disk depending on the position of the disk during rotation;
recover a third backscattered signal SR3′ alternating between a third signal backscattered by the disk and a third signal backscattered by the object.

The calibration device is also configured to feed the laser rangefinder TL with at least a fraction of the third backscattered signal. The backscattered signal therefore generates rapid periodic transitions (of around tens of ns) between two distances (focused at the surface of the disk and focused at the object when the incident measurement beam passes through the patterns on the disk). These rapid calibrated transitions between two distances allow the response of the rangefinder to be qualified. This results in a dynamic, contactless distance calibration. It should be noted that the distance do must be precisely known in order to calibrate the rangefinder, and the disk probe distance is preferably known in order to facilitate the adjustment of the diagnostics.

According to one embodiment of this variant, the object is configured to be positioned at a plurality of determined distances along said axis of incidence N of the third incident signal, in order to obtain several distance standards (for example, the distance do can be varied between 1 and 100 mm).

According to one embodiment compatible with all the aforementioned variants and also illustrated in FIG. 8, the rotating disk is disposed in a primary or secondary vacuum containment chamber EV so that the disk can rotate friction-free using a suitable motor. The chamber is preferably shielded in order to protect the user from the risk of the rotating disk shattering.

The probes DIR1, and DIR2 and/or DIR3, as applicable, can be placed inside (internal probe) or outside (external probe) the chamber. In the latter case, it is worthwhile inserting a window H in order to allow the incident beam (propagating in free space) to reach the disk (see, for example, DIR3 in FIG. 8).

The velocimeter, and as applicable the rangefinder, are placed outside the chamber.

According to one embodiment illustrated in FIGS. 2 and 8, the calibration device according to the invention further comprises a balancing mass ME disposed on the disk and intended to balance the mass of the mirror attached to the disk.

According to one embodiment, the calibration device according to the invention is configured so that the first maximum standard tangential velocity vte1max reached by the disk is greater than or equal to 100 m·s⁻¹. It is then possible for the device according to the invention to perform a velocity calibration over a wide range of velocities: between 1 and 100 m/s using the device in its version without re-injection, then up to 2,000 m/s or even 5,000 m/s using the version with re-injection, granting access to multiples of around 20 of vte1.

Achieving a tangential velocity of 100 m/s and above involves optimizing the rotating disk in several respects. With such optimizing, the inventors have simulated rotating disks capable of reaching 700 to 800 m/s.

Placing the disk in a vacuum chamber is a first option.

A second option is to optimize the shape of the disk.

After various studies, the inventors have established that a disk such as that illustrated in FIG. 9, with a variable thickness, thicker at the center than at the edge, improves the mechanical strength at the center of the disk where the stresses are greatest. In other words, according to one embodiment, the disk D has, at least on the periphery, a thickness e(r) that decreases with respect to a distance r from the axis of rotation.

In order to increase the mechanical strength at the center of the disk, and thus substantially increase the rotation velocity of the disk before it is damaged, according to one embodiment, the disk is made of two materials, made with a first material Mat1 for the central part of the disk and a second material Mat2 for the peripheral part.

According to one embodiment, the through-patterns are notches CR located on the periphery of the disk. Patterns machined on the edge of the disk in the form of notches allow more absolute transitions to be provided for the velocities and distances.

According to one embodiment, the disk comprises a shoulder EP located on the periphery of the disk. Preferably, its external diameter defines the diameter of the disk Dd (radius Rd). The purpose of this shoulder is to precisely locate the distance between the axis of rotation and the external diameter of the shoulder. Preferably, the focused incident beam is tangent to the edge of the shoulder of the radius Rd. Knowing the diameter of the focused beam (Dsp=2·Rsp) allows the actual measurement radius to be precisely determined:

$${R}_{m} = {R}_{d} + {R}_{sp} ) .$$

In addition, the shoulder also acts as a stiffener and improves the mechanical strength of the outer part of the disk.

Preferably, the edge of the mirror is attached to the shoulder and the mirror is perpendicular to the outer diameter of the shoulder.

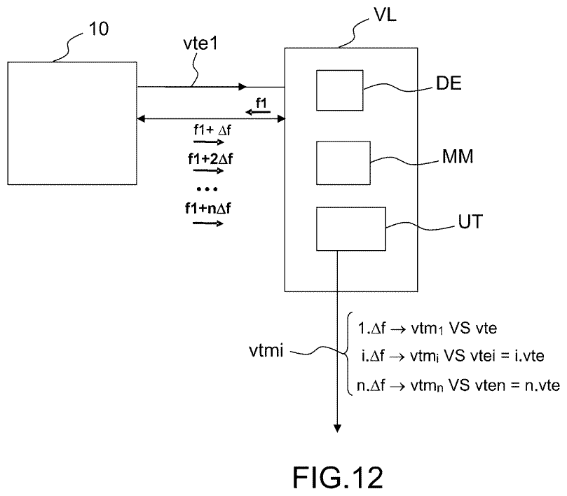

According to a second aspect, the invention relates to a calibrated velocity measurement system 20 illustrated in FIG. 12. The system 20 comprises a laser velocimeter VL and a calibration device according to the first aspect of the invention.

The velocimeter VL comprises, in a known manner:
a transmission/reception device DER configured to transmit a light signal at the first frequency f1 and to receive a frequency-shifted signal reflected by a target;
a measurement module MM configured to superimpose a reference signal and the signal reflected by the target and to detect a beat signal at a beat frequency corresponding to the frequency shift;
a processing unit UT configured to digitize the beat signal and to extract velocity information from the beat frequency.

The laser velocimeter VL of the system 20 is configured to be coupled to the calibration device 10 during calibration.

During calibration, the velocimeter VL is configured to receive the value of the first standard tangential velocity vte1 from the calibration device 10.

The transmission/reception device DER is also configured to transmit said first light signal at said first frequency f1 to the calibration device 10.

The device DER is also configured to receive, from the calibration device 10, i) the fraction of the first reflected signal having a frequency shifted from the first frequency by a Doppler shift Δf corresponding to said first standard tangential velocity, and ii) the fraction of the plurality of additional reflected signals respectively having a frequency shifted from the first frequency by a plurality of shifts equal to i times the Doppler shift (Δf), with i varying from 2 to n.

During calibration, the first reflected signal and the plurality of additional reflected signals, originating from the calibration device 10 and received by the transmission/reception device DER, are processed in the same way as the signal reflected by the target by the processing unit UT of the velocimeter VL.

The processing unit UT of the velocimeter VL is thus also configured to then extract a first tangential measurement velocity vtm1 from the Doppler shift Δf that is to be compared with the first standard tangential velocity vte1 received from the calibration device, and to extract a plurality of associated additional tangential measurement velocities vtmi from the plurality of shifts equal to i times the Doppler shift Δf that are to be respectively compared with a plurality of additional standard tangential velocities vtei respectively equal to i times the first standard tangential velocity vte1.

1. A calibration device intended to be coupled to a laser velocimeter (VL) comprising:
a disk (D) configured to rotate about an axis of rotation (AR) at a determined angular velocity (ω);
a mirror (M) rigidly connected to the disk, having a surface (SM);
a first illumination/reception device (DIR1) configured to:
receive a first light signal (S1) at a first frequency, said first light signal originating from the laser velocimeter;
orient and focus the first light signal so as to form a first incident signal illuminating the surface of the mirror at a normal incidence for a position of the disk during a passage of the disk, and over a diameter on said determined surface, with the center of said diameter being located at a determined measurement distance (Rm) from said axis of rotation (AR);
recover a first signal (SRi) reflected by the mirror at a frequency shifted from the first frequency by a Doppler shift (Δf);
with said calibration device also being configured to output at least a fraction of said first reflected signal and a value of a first standard tangential velocity (vte1) determined from said angular velocity (ω) and said measurement radius (Rm), intended for said laser velocimeter (VL) to be calibrated.

2. The calibration device according to claim 1, further comprising a reinjection device (DRI) configured to recover, amplify and reinject, into the first illumination/reception device, the first reflected signal and a plurality of additional reflected signals formed by successive reflections on said mirror during said passage of the disk,
with said calibration device also being configured to output a fraction of said plurality of additional reflected signals, intended for said laser velocimeter (VL) to be calibrated.

3. The calibration device according to claim 2, wherein the first illumination/reception device is fiber-optic and wherein the reinjection device comprises a first coupler (CO1), a first optical amplifier (OA1) and an optical fiber mirror (OFM).

4. The calibration device according to claim 2, wherein the first illumination/reception device is fiber-optic and wherein the reinjection device comprises a second coupler (CO2) and a second optical amplifier (OA2) configured to loop back onto the second coupler (CO2).

5. The calibration device according to claim 1, wherein the disk comprises through-patterns (MT) evenly disposed on the periphery of the disk over a determined radius (Rmot), the calibration device further comprising a second illumination/reception device (DIR2) configured to:
receive a second light signal (S2′) at a second frequency, said second light signal originating from the laser velocimeter;
orient and focus the second light signal so as to form a second incident signal illuminating, with a non-zero angle of incidence (α) relative to the plane of the disk, either the patterns or the surface of the disk depending on the position of the disk during rotation;
recover a second signal (SR2) backscattered by the disk, alternating between a second non-zero amplitude signal originating from the backscattering of the surface of the disk, and a second zero amplitude signal when the second incident signal passes through the disk via a pattern,
with said calibration device also being configured to provide said laser velocimeter (VL) with at least a fraction of said second backscattered signal.

6. The calibration device according to claim 1 and also intended to be coupled to a laser rangefinder (TL), wherein the disk comprises through-patterns (MT) evenly disposed on the periphery of the disk on a determined radius (Rmot), the calibration device further comprising:
a backscattering object (Obj) disposed under the disk at a determined distance (do) from the disk and so as to backscatter light that has passed through the patterns;
a third illumination/reception device (DIR3) configured to:
receive a third light signal (S3′) at a third frequency, with said third light signal originating from the laser rangefinder (TL);
orient and focus the third light signal so as to form a third incident signal illuminating, along an axis of incidence (N) normal to the surface of the disk, either the through-patterns or the surface of the disk depending on the position of the disk during rotation;
recover a third backscattered signal (SR3′) alternating between a third signal backscattered by the disk and a third signal backscattered by the object, with said calibration device also being configured to supply said laser rangefinder (TL) with at least a fraction of said third backscattered signal.

7. The calibration device according to claim 6, wherein the object is configured to be positioned at a plurality of determined distances along said axis of incidence (N) of the third incident signal.

8. The calibration device according to claim 1, further comprising a balancing mass (ME) disposed on the disk and intended to balance a mass of the mirror.

9. The calibration device according to claim 1, wherein the disk has, at least on its periphery, a thickness (e) that decreases with respect to a distance (r) from the axis of rotation.

10. The calibration device according to claim 1, wherein the through-patterns are notches (CR) located on the periphery of the disk.

11. The calibration device according to claim 1, wherein the disk is made of two materials, with a first material for a central part of the disk and a second material for a peripheral part.

12. The calibration device according to claim 1, configured so that a first maximum standard tangential velocity reached (vte1max) by the disk is greater than or equal to 100 m·s⁻¹.

13. The calibration velocity measurement system comprising a laser velocimeter (VL) and a calibration device according to claim 1, the laser velocimeter being configured to be coupled to said calibration device during calibration, the laser velocimeter comprising:
a transmission/reception device (DER) configured to transmit the first light signal at said first frequency (f1) and to receive a frequency-shifted signal reflected by a target;
a measurement module (MM) configured to superimpose a reference signal and said signal reflected by the target, and to detect a beat signal at a beat frequency corresponding to the frequency shift;
a processing unit configured to digitize the beat signal and to extract velocity information from the beat frequency;
with the laser velocimeter (VL) also being configured, during calibration, to receive said value of a first standard tangential velocity (vte1) delivered by the calibration device and such that:
the transmission/reception device transmits said first light signal at said first frequency (f1) to the calibration device;
the transmission/reception device receives, from the calibration device, the fraction of said first reflected signal having a frequency shifted from the first frequency by a Doppler shift (Δf) corresponding to said first standard tangential velocity; and
the fraction of the plurality of additional reflected signals respectively having a frequency shifted from the first frequency by a plurality of shifts equal to i times the Doppler shift (Δf), with i varying from 2 to n;
the processing unit extracts a first tangential measurement velocity (vtm1) from said Doppler shift that is to be compared with the first standard tangential velocity (vte1), and extracts a plurality of associated additional tangential measurement velocities (vtmi) from said plurality of shifts equal to i times the Doppler shift (Δf) that are to be respectively compared with a plurality of additional standard tangential velocities (vtei) respectively equal to i times the first standard tangential velocity (vte1).
